(19) United States
(12) Patent Application Publication
(10) Pub. No.: US 2018/0049851 A1
(43) Pub. Date: Feb. 22, 2018

(54) CAP FOR DENTAL PROSTHESIS

(71) Applicant: LEONE S.p.a., Sesto Fiorentino (FI) (IT)

(72) Inventors: Gabriele SCOMMEGNA, Tavarnuzze Impruneta (FI) (IT); Maurizio DOLFI, Firenze (IT)

(21) Appl. No.: 15/560,728

(22) PCT Filed: Mar. 23, 2016
(86) PCT No.: PCT/IT2016/000075

§ 371 Date: Sep. 22, 2017

(30) Foreign Application Priority Data
Mar. 30, 2015 (IT) FI2015A000095

(51) Int. Cl. A61C 13/277; A61C 8/00; A61C 5/70

(52) U.S. Cl. CPC A61C 13/277; A61C 5/70; A61C 8/0074

(57) ABSTRACT

The invention relates to a cap for removable dental prosthesis, a removable prosthesis and a process for the production of a removable prosthesis; the cap for removable dental prosthesis is suitable to be anchored by one or more implants which consist of an artificial root (1) and an abutment (4), said cap (6) being adapted to be received in the prosthesis (8) to be fit on said abutment (4) for defining a stable but removable constraint which allows the detachment of the prosthesis from the abutment; the cap is provided with a threaded outer surface (68).

The present invention relates to a cap for the anchorage of a dental prosthesis, a dental prosthesis and a process for the realization of a dental prosthesis.

The cap is particularly used in the so-called “overdenture” system, which consists of a removable dental prosthesis anchored to artificial implants each constituted by an artificial root and a correspondent abutment.

The root is implanted in the maxillary bone or in the mandible bone, while the abutment is associated with the root by means of a conometric coupling or with other systems. The abutment is usually provided with a small ball, placed on its free (or outer) end, which constitutes the point of support on that the prosthesis will be anchored to the implant. The end of the abutment can also be differently shaped, and therefore it can be of non-spherical shape. Usually, for a total prosthesis, there are two implants for each dental arch and therefore are two the balls which allow the fixing of the prosthesis. For this reason, the prosthesis is provided with a pair of caps fixedly inserted in its base to be worn on the balls and to define a stable fastening that still allows the detachment of the prosthesis for the cleaning of the same or for other reasons.

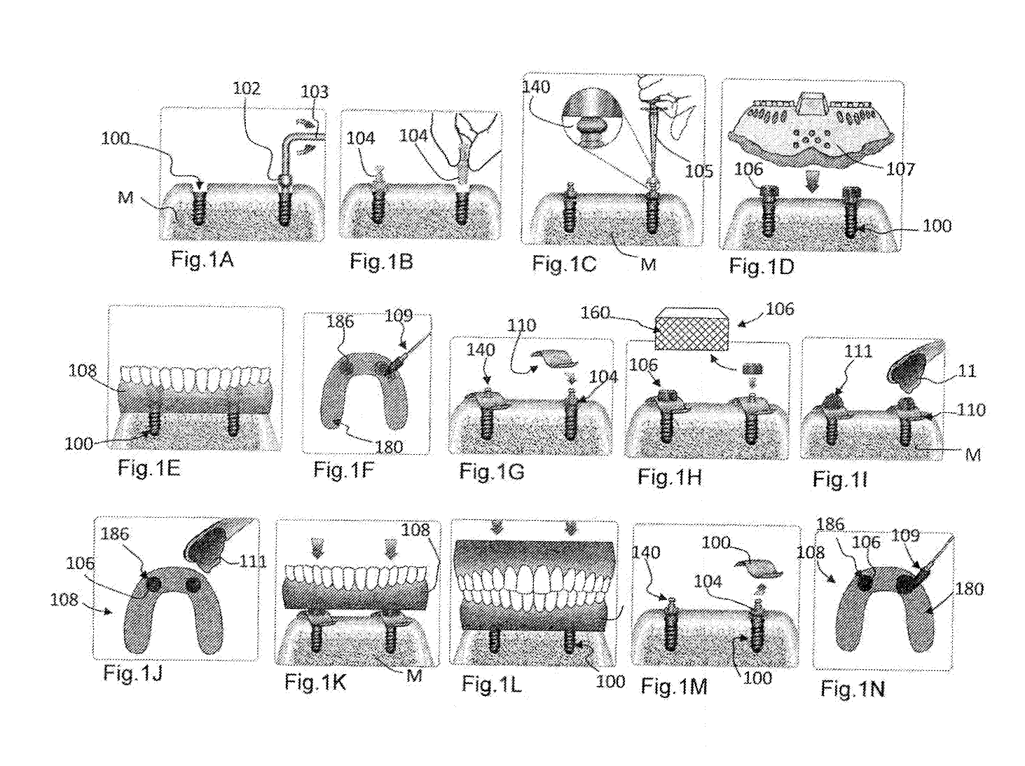

FIGS. 1A to 1N schematically illustrate a known procedure for the production of a dental prosthesis of the type “overdenture O-ring”.

With reference to FIG. 1A, once the implant (100) has been inserted into the maxillary bone or in the mandible bone (M) and the healing of the soft tissues has been reached, the so-called healing plugs are removed (102) with a suitable tool (103), as shown in FIG. 1A. Then, the abutments (104) (see FIG. 1B) for the overdenture O-ring system are been chosen according to the available height of the gingiva and the inclination of the implants. According to the procedural operations, the abutment (104) has to emerge from the gum for at least 1 mm to avoid that subsequently the caps compress the soft tissues. After having washed and dried thoroughly the internal of the implant, the insertion of the abutment for overdenture O-ring (104) in the system (101) is performed, with the application of an impulsive force along the longitudinal axis, for example by means of a striker element (105), as shown in FIG. 1C.

Subsequently (FIG. 1D) the caps (106) are placed on the abutments (104) and the dental imprint was taken by means of a spoon (107) for imprints of known type. In this way, the final prosthesis will be provided with suitable seats for the caps (106). The caps (106) are then removed. When the prosthesis (108) is ready, the same is placed in the mouth for a general control, in particular to verify the space destined to the housing of the caps (106), as shown in FIG. 1E. Then, the prosthesis (108) is subjected to a milling, in particular on its base (180), in correspondence of the seats (186) intended to receive the caps (106) in order to obtain a corrected mucous support of the prosthesis without friction. In FIG. 1F with (109) is indicated a milling device used for this purpose. When a successful stabilization is achieved, (see FIG. 1G) a separator formed with a portion of a dental dam (110) is placed in correspondence of each abutment (104) to prevent the soft tissue to come in contact with the acrylic. FIG. 1H shows the next stage, which requires the insertion of the caps (106) on the abutments (104) and FIG. 1I shows the subsequent phase that foresees the casting of acrylic (111) on the caps (106). The acrylic (111) is then inserted (see FIG. 1J) in the seats (186) for the caps (106) formed in the prosthesis (108), which is then applied in the patient's mouth over the abutments (FIG. 1K). Subsequently, the mouth of the patient has been closed in the proper occlusal position, as shown in FIG. 1L. At the end of the polymerization process of the acrylic, the prosthesis (108) is removed from the patient's mouth. The caps (106), thanks to their particularly retentive surface (160), visible in the enlarged detail of FIG. 1H, remain inside of the prosthesis (108) integrally associated to the same. The dams (110) are then removed from the abutments (104), as shown in FIG. 1M. At the conclusion of the procedure, as shown in FIG. 1N, the excess of acrylic is removed until the total uncovering of the lower edge of the cap (106).

A drawback of the prosthesis of known type lies in the impossibility of replacement of the caps. The replacement may be required for the wearing of the material or for damages at the caps occurred during the realization of the prosthesis, for example during finishing. The inability to replace damaged or worn cap makes it impossible to properly use the prosthesis even if the damage concerns a very modest cost component as the cap.

Among the aims of the present invention there is to eliminate the aforesaid drawbacks of prior art.

This result is achieved, according to the present invention, by adopting the idea to realize a cap for the anchorage of a dental prosthesis and a dental prosthesis having the characteristics indicated in the independent claims. Other features of the present invention are object of the dependent claims.

Among the advantages of the present invention is the fact that, in case of need, it is possible to replace one or more caps mounted on the prosthesis; that the caps can easily be replaced by a simple screwing/unscrewing tool thanks to the internal shape of the cap; that the cap may be shaped to also allow the acceptance of an abutment having a frusto-conical head; that the cap is formed by a single body, so simplifying the manufacture of the cap and the realization of the prosthesis; that a prosthesis made in accordance with the present invention is robust and substantially maintains unchanged its characteristics compatibly with the normal conditions of use; that a process for the realization of the prosthesis according to the present invention is able to provide a prosthesis in which the caps are able to allow optimal coupling with the abutment and, at the same time, can be easily and efficiently separated from the prosthesis body; that the resources necessary to the implementation of the present invention are comparable, both in terms of time and cost, to those of a conventional prosthesis; furthermore, the formation of the prosthesis procedure involves only a few changes compared to conventional procedures, for which dental technicians are facilitated in learning the correct execution.

These and other advantages and features of the present invention will be best understood by anyone skilled in the art from the following description and with the help of the attached drawings given as a practical exemplification of the invention, but not to be considered in a limitative sense, wherein:

FIGS. 1A, 1B, 1C, 1D, 1E, 1F, 1G 1H, 1I, 1J, 1K, 1L, 1M, 1N schematically represent a known process for the production of a prosthesis of the type called overdenture O-ring;

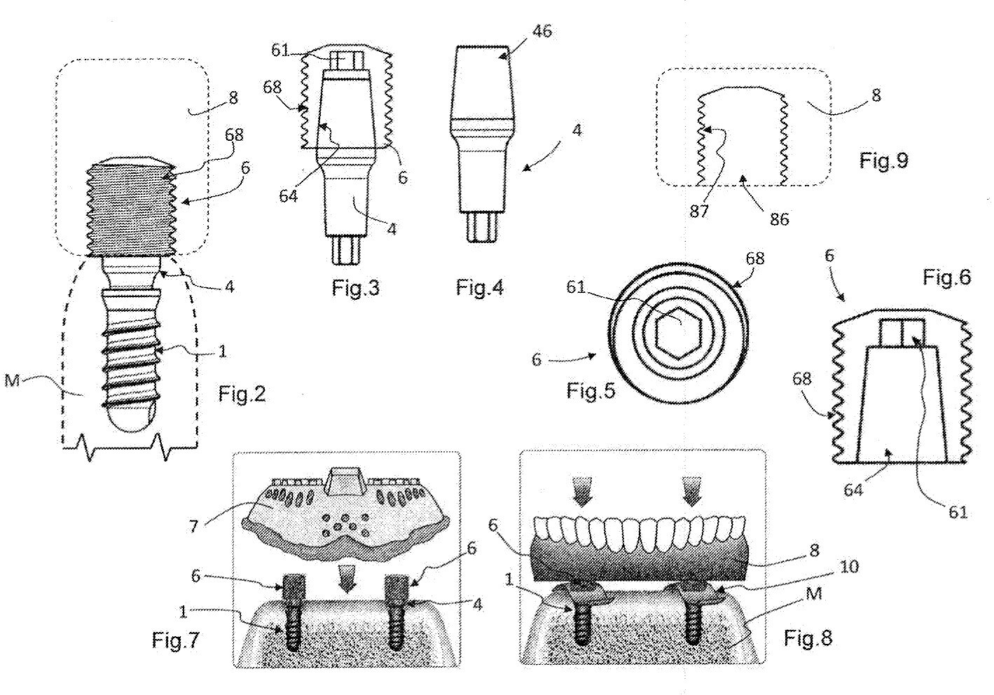

FIG. 2 is a schematic side view with parts removed of a possible example of embodiment of a cap according to the invention, represented together with an abutment fixed to the artificial root of the corresponding dental implant and in which the prosthesis and the gingiva of patient are represented in a schematic way;

FIGS. 3, 4 are schematic side views of an abutment, which in FIG. 3 is associated with a cap represented in transparency, while FIG. 4 is represented without the cap;

FIG. 5 is a plan view from below of the cap of FIGS. 2, 3;

FIG. 6 is a view according to a longitudinal section of the cap of FIGS. 2, 3, 5;

FIGS. 7, 8 represent schematically some steps of a method for manufacturing a prosthesis according to the invention; and

FIG. 9 shows partially a prosthesis according to the invention, in which is visible the threaded seat that is formed in it.

With reference to the drawings of FIGS. 2-9, a cap (6) in accordance with the present invention is used for making a removable prosthesis (8) anchored by means of two dental implants, each comprising an artificial root (1) and an abutment (4). The artificial root (1) is implanted in the mandible or maxilla (M) in a known manner and therefore not described.

The cap (6) is intended to be inserted into the prosthesis (8) for be fitted on the abutment (4) and it is adapted to define a stable but removable constraint which permits the detachment of the prosthesis from the abutments (4) when necessary. The cap (6) of the invention is provided with a threaded outer surface (68). This allows replacement of the cuff (6) in case of damage or for other requirements. The removal of the cap (6) from the prosthesis (8) is achievable thanks to an internal seat (61) of the cap, complementarily shaped with respect to a tool used to unscrew and tighten the same cap (6) from/into the prosthesis (8) to which it is associated. In the example shown in FIG. 5 and FIG. 6 said inner housing (61) has a hexagonal shape in plan to allow the insertion of a correspondingly shaped key. Obviously there are other possible conformations of the tool used, as well as the size and conformation of the cap (6).

The cap (6) is further provided with an internal cavity (64) adapted to receive a corresponding frusto-conical frustum portion (46) presented from the abutment (4) with which the cuff (6) is intended to couple. This allows to properly attach the cap (6) to the abutment (4) ensuring a remarkable stability of the prosthesis (8).

As shown in FIG. 6, the aforementioned housing (61) is above the cavity (64) for coupling with the abutment (4).

The present invention also relates to a prosthesis provided with the cap (6) abovementioned. In particular, the prosthesis (8) is characterized by the fact of being provided with at least a cap (6) which can be fixed to the abutment (4) and which has a threaded outer surface (68) which is engaged in a correspondingly threaded seat (86) formed on the prosthesis (8). The prosthesis (8) is therefore provided with a female thread (87) in which the male screw (68) of the cap (6) can be screwed.

In practice, as described in the attached drawings, the cap (6) is constituted by a single body provided with a threaded outer surface (68) and an internal seat (61) shaped complementarily with respect to a tool used to unscrew and tighten the same cap (6) from/into the prosthesis (8) to which it is associated.

A prosthesis (8) according to the invention is therefore provided with a female thread (87) in which is screwed the male thread (68) of the cap (6).

The process for the construction of a removable prosthesis (8) according to the present invention is of the type usable for the formation of a conventional prosthesis, being essentially similar to the procedure described in FIGS. 1A-1N. The process of the invention (of whom two operating phases are schematically shown in FIGS. 7-8) is characterized in that it includes a step of inserting, in the base of the prosthesis (8), at least one cap (6) fixable to the abutment (4) and having a threaded outer surface (68), the insertion of said cap (6) determining the formation of a seat (86) correspondingly threaded into the prosthesis (8). In the drawings of FIGS. 7-8, the references 7 and 10 mark a spoon and a dam which correspond, respectively, to the spoon 107 and the dam 110 of the FIGS. 1A-N drawings.

More particularly, the process of the invention has the first steps that are similar to the procedure already described with reference to FIGS. 1A-1F. After these steps, a cap (6) is fitted on each abutment (4) as shown in FIG. 3. Then, in the seats (86) so formed in the base of the prosthesis (8) is entered the acrylic resin and acrylic resin is put on each cap (6).

In practice, during the substantial embedding of the caps (6) in the prosthesis body (8), the threaded surface (68) determines the formation of a corresponding female thread (87) on the walls of the seat (86) which receives the same cap (6).

In a final step, after the polymerization of the resin, the procedure is similar to that described with reference to FIG. 1N.

The present invention therefore allows to provide a dental prosthesis in which the connection between cap (6) and intra-bone implant (1) is particularly effective, in particular when the union between the abutment (4) and cap (6) is of conometric type, guaranteeing the possibility of detachment of the cap (6) from the prosthesis (8) thanks to the screw connection between these two elements.

In the present description reference is made to at least one cap (6) but it is noted that the inventive concept is extended to a number of caps that can be equal to two, as expected generally in the most widespread form of embodiment of the dental prosthesis (8) anchored to two dental implants, or greater than two whereas the number of usable dental implants for anchoring the prosthesis is greater than two.

For realizing the invention can be used the materials normally used to make the dental prosthesis, implants and anchoring caps of the prosthesis to the implants. The invention is not limited to those described and illustrated, but can be widely modified with regard to the nature and arrangement of the materials used, without departure from the inventive teaching as disclosed and claimed.

1. Cap for removable dental prosthesis suitable to be anchored by one or more implants which consist of an artificial root (1) and an abutment (4), said cap (6) being adapted to be received in the prosthesis (8) to be fit on said abutment (4) for defining a stable but removable constraint which allows the detachment of the prosthesis from the abutment; cap characterized in that it is provided with a threaded outer surface (68).

2. Cap according to claim 1, characterized in that it is provided with an inner frusto-conical cavity (64) adapted to receive a corresponding frusto-conical portion (46) presented by the abutment (4) with which the cap (6) is intended to couple.

3. Cap according to claim 1, characterized in that is provided with an internal seat (61) complementarily shaped with respect to a tool used to unscrew and screw the same cap (6) from/into the prosthesis (8) to which it is associated.

4. Cap according to claim 3, characterized in that said inner seat (61) has polygonal shape in plan.

5. Removable prosthesis of the type which can be anchored to one or more implants which consist of an artificial root (1) and an abutment (4), comprising at least one cap (6) which can be reversibly fitted on said abutment (4), characterized in that said cap (6) has a threaded outer surface (68) adapted to engage a correspondingly threaded seat (86) of said prosthesis (8).

6. Prosthesis according to claim 5, characterized in that the cap (6) is provided with an internal frusto-conical cavity (64) adapted to receive a corresponding frusto-conical portion (46) presented from the abutment (4) with which the cap (6) is intended to couple.

7. Prosthesis according to claim 5, characterized in that the cap (6) is provided with an internal seat (61) complementarily shaped with respect to a tool used to unscrew and screw the same cap (6) from/into the prosthesis (8) to which it is associated.

8. Process for the production of a removable prosthesis of the type which can be anchored by one or more implants which consist of an artificial root (1) and an abutment (4), comprising a step of insertion into said prosthesis (8) of at least a cap (6) fixable to said abutment (4), characterized in that said cap (6) has a threaded outer surface (68), the insertion of said cap (6) determining the formation of a correspondingly threaded seat (86) in said prosthesis (8).

9. Process according to claim 8, characterized in that the cap (6) is provided with an internal frusto-conical cavity (64) adapted to receive a corresponding frusto-conical portion (46) presented from the abutment (4) with which the cap (6) is intended to couple.

10. Process according to claim 8, characterized in that the cap (6) is provided with an internal seat (61) complementarily shaped with respect to a tool used to unscrew and screw the same cap (6) from/into the prosthesis (8) to which it is associated.
